(19) United States
(12) Patent Application Publication
(10) Pub. No.: US 2011/0104330 A1
(43) Pub. Date: May 5, 2011

(54) PROCESS FOR MANUFACTURING CHEWING GUM HAVING A COATING LAYER, AND THE CHEWING GUM OBTAINABLE BY SAID PROCESS

(75) Inventors: Roberto Colle, Lainate (MI) (IT); Andrea Sarrica, Lainate (MI) (IT)

(73) Assignee: PERFETTI VAN MELLE S.P.A., Lainate (IT)

(21) Appl. No.: 12/992,276

(22) PCT Filed: May 12, 2009
(86) PCT No.: PCT/EP09/03358

§ 371 Date: Jan. 4, 2011

(30) Foreign Application Priority Data
May 15, 2008 (IT) MI2008A000889

(51) Int. Cl. A23G 4/20

(52) U.S. Cl. 426/5

(57) ABSTRACT

The present invention relates to a process for manufacturing chewing gum, which said chewing gum comprises a core formed by at least one gum base and at least one sweetener. Said process comprises the steps of: a) mixing said gum base with at least one sweetener; b) processing said formulation to obtain a plurality of cores; c) placing said cores in contact with a quantity of water sufficient to wet at least the outer surface of each core; and d) coating the wetted outer surface of each core with a coating substance in particulate form.

The present invention relates to a process for the manufacture of chewing gum with a coating layer which gives the finished product excellent organoleptic characteristics which are particularly liked by consumers and appreciable as soon as chewing of the gum begins. The invention also relates to the gum obtainable by said process.

### PRIOR ART

Chewing gum is typically made from a gum base to which one or more sweeteners are added, with the main function of making it more pleasurable for users to chew the gum.

Some well-known chewing gums are made in stick form; this was the first type of chewing gum to be launched on the market, with great commercial success. However, it has been found that stick chewing gum presents some drawbacks, such as poor flavour release in the early steps of chewing and premature aging, with consequent loss of flavour and elasticity of the rubber, which becomes particularly hard to chew.

In order to eliminate said drawbacks, chewing gum manufacturers have made a new type of product by replacing stick chewing gum with pellet-shaped chewing gum. In particular, a type of chewing gum has been made which comprises a central body (also called the core or centre in trade jargon), formed by a gum base to which one or more sweeteners are added, with a coating consisting of one or more layers of sugar or other sweetening substance. The step of application of said coating is technically known as “sugar-coating”, and the chewing gum thus obtained is called “dragee” or “pellet” gum. The commercial success of this product is mainly due to the fact that the coating layer prolongs the life of the product (which maintains its elasticity and organoleptic properties for longer) and rapidly releases its flavour from the very first steps of chewing, an aspect which is particularly liked by users. The sugar-coating process, in the case of both hard and soft coatings, requires the use of a syrup, ie. a concentrated solution comprising water and at least one sugar or polyol, which is applied to the central bodies or cores of the chewing gum.

Numerous documents of the prior art relate to specific aspects of the coating process, and to products obtained from syrups of suitable compositions. See, for example, EP 1,481,597; WO 03/00068; EP 037,407; and U.S. Pat. No. 5,248,508. In particular, WO 06/122220 describes a confectionery product coated with a syrup of suitable composition and subsequently with alditol crystals (the “sanding” step), which releases an intense flavour and a pleasant sensation of freshness as soon as chewing begins.

However, the Applicant has found that known pellet gums, though presenting the above-mentioned advantages by comparison with stick gum, also present some drawbacks, mainly due to the use of syrups in their manufacture.

The Applicant has found that the use of a syrup in the coating process increases both the complexity and the duration of the process. For example, the syrup application step requires the time taken to distribute the syrup on the cores to be long enough for said distribution to be as even as possible. Said application step, like the further steps characterising the coating process (such as the drying step in the case of hard coatings), must be repeated for a number of cycles which generally ranges between a minimum of five and a maximum of thirty. Said process is therefore a batch process, and particularly time- and energy-intensive. There are also some significant drawbacks connected with the production of the syrup which must be used in the coating process. The process used to obtain a syrup is complex (for example, specific measures are required to ensure that the syrup has the desired concentration), time-intensive and particularly expensive in terms of the raw materials used and the equipment (for example, particular attention is required in the preparation of solutions of binding agents, such as gum arabic or gelatin, which represent a typical ingredient of the syrup-making process).

The “dusting” technique, whereby the product to be treated (such as a pellet) is sprayed with dry steam, after which a thin layer of powdered sugar or polyol is applied, is also known in the coating industry. The dry steam anchors said powder to the surface beneath it, albeit very weakly. Said powders, as such, typically have a very limited size, the mean particle size generally being less than 50 μm.

Although said technology represents an alternative to the use of the above-mentioned syrups, it also involves a number of disadvantages. Primarily, the product thus obtained presents very poor organoleptic qualities because the powdered sugar or polyols, being present in very small amounts and being of very small size, dissolves immediately in the very early steps of chewing, leading to a very short-lived perception of flavour.

### DESCRIPTION OF THE INVENTION

The Applicant has perceived the need to prepare a process for manufacturing a chewing gum which eliminates the disadvantages of known manufacturing processes.

In particular, the Applicant has perceived the need to prepare a process for manufacturing chewing gum which is simple, fast, economical, and at the same time guarantees that the finished product will have excellent organoleptic qualities.

In other words, the Applicant has perceived the need to produce a chewing gum with a coating layer obtained by applying a coating substance in particulate form to the central body or core, while avoiding the use of a syrup as adhesive agent to anchor said particles to the outer surface of the central body or core.

The Applicant consequently decided to devise a manufacturing process able to create a permanent (ie. strong and lasting) bond between the particles of a coating substance (such as one or more sugars or polyols or combinations thereof) and the central body or core of the chewing gum, having perceived (i) the need to enhance the organoleptic qualities of the finished product by using particles of the coating substance, which give a much better result than powders of the same coating substance, and (ii) the need to eliminate the problems caused in the manufacturing process, as stated above, by the use of a syrup as a coating means in itself or as an adhesive to anchor powders or crystals to the surface of the chewing gum core.

The Applicant has found that the particles of a coating substance can be advantageously anchored to the core of the chewing gum by placing them in contact with a fluid consisting essentially of water, preferably hot water, for example by spraying or immersion (bath). The Applicant has found that if the outer surface of the core is suitably wetted with water, the particles of the coating substance will cling firmly to said core. In particular, therefore, the invention relates to a process for manufacturing chewing gum, which said chewing gum comprises a core formed by at least one gum base and at least one sweetener, which said process comprises the steps of:
a) processing a chewing gum formulation to obtain a plurality of cores;
b) placing said cores in contact with a fluid consisting essentially of water in order to wet the outer surface of each core, and
c) coating the wetted outer surface of each core with at least one coating substance in particulate form.

The term “fluid consisting essentially of water” means water in the liquid or steam state, possibly mixed with other liquids such as flavourings or ethanol. The use of water at a temperature of between 20° C. and 100° C. is preferred; more preferably between 25° C. and 75° C.; and even more preferably between 30° C. and 50° C. The term “placing in contact” means any suitable technique such as spraying, immersion or wetting of the cores, or equivalent techniques. The choice of the most suitable method will depend on the type of manufacturing plant and whether the manufacturing process is continuous or discontinuous.

The term “particulate form” means a solid in the form of an amorphous powder, encapsulated, granulated, coated with flavouring substances or crystalline, having a particle size greater than 50 p.m.

### BRIEF DESCRIPTION OF FIGURES

FIGS. 1a and 1b show the block diagram of a first form of embodiment of the manufacturing process according to the invention, and

FIG. 2 shows the block diagram of a second form of embodiment of the manufacturing process according to the invention.

### DETAILED DESCRIPTION OF THE INVENTION

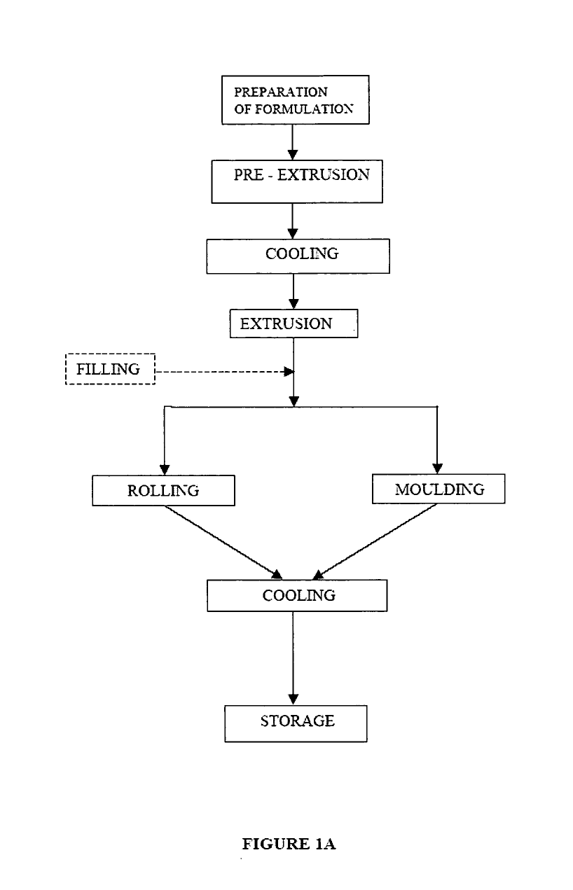

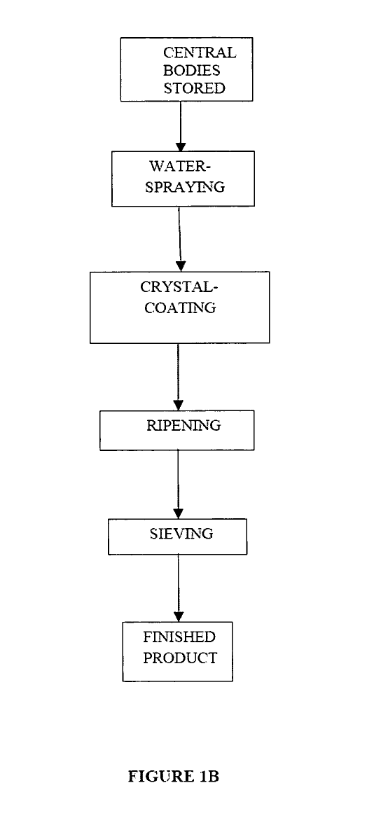

FIGS. 1a and 1b represent the block diagram of a batch manufacturing process of a coated chewing gum according to a first form of embodiment of the invention.

As shown in FIG. 1a, the first step of the process is the preparation of a formulation from which the core of the chewing gum is obtained. As already stated, the core typically comprises at least one gum base and at least one sweetener, which can be chosen from sugars (in solid form, such as dextrose, or in the form of a syrup, such as glucose syrup), polyols (in solid form, such as sorbitol, or in the form of a syrup, such as maltitol syrup), and combinations thereof. The formulation may also contain one or more of the following substances: flavouring agents in solid or liquid form, wetting agents, technological adjuvants such as emulsifiers or plasticisers, pharmacological active constituents, plant extracts, functional ingredients such as vitamins or mineral salts, and colorants.

When the formulation has been prepared (ie. its constituents have been chosen and suitably measured), it is processed to obtain a plurality of cores constituted by the chewing gum. The formulation can be processed by any known methodology, such as the use of continuous extruders or batch mixing equipment. According to the manufacturing process illustrated in FIG. 1a, once the formulation has been obtained it undergoes two consecutive extrusion steps. In detail, FIG. 1a illustrates a step of pre-extrusion (first extrusion step) from which the formulation is extruded in the form of slabs with a very soft texture. After a cooling step, said slabs are subjected to an extrusion step (second extrusion step) from which the formulation, suitably processed and with its constituents evenly amalgamated, is extruded in the form of cylindrical ropes or sheets. As shown in FIG. 1a, in order to form the plurality of cores of the chewing gum, the formulation exiting from the extrusion step (second extrusion step) is sent to a subsequent rolling or moulding step. Preferably, the cores obtained from the rolling or moulding step present a discoid, cylindrical, cubic or spherical geometrical configuration, with a longitudinal cross-section which is diamond-shaped, rectangular or rectangular with rounded corners (pillow-shaped). The cores thus obtained preferably undergo a cooling step, which is consequently subsequent to the rolling or moulding step.

As shown in FIG. 1a, the manufacturing process according to the invention can also include a step of introduction into the extruded formulation of a substance designed to fill the body of the chewing gum, said introduction step being performed after the extrusion step and before the rolling or moulding step. The filling can be liquid or solid and, depending on the type of core and filling material, the latter may be visible from the outside through the core.

The batch manufacturing process according to the form of embodiment illustrated in FIG. 1a includes a step of storage of the cores after they have been obtained by rolling or moulding and cooled.

FIG. 1b represents the block diagram of the successive steps of the batch manufacturing process illustrated so far by reference to FIG. 1a.

In detail, according to the invention, the previously stored cores undergo a step of spraying with water in order to wet at least the outer surface of each core.

Subsequently, when the cores possess the desired degree of wetting, which has been uniformly applied to all the cores, the manufacturing process according to the invention comprises a step of coating the wetted outer surface of each core with particles of a coating substance.

The spraying step is advantageously performed with hot water, which softens the surface of the cores and therefore ensures better adherence and anchorage of the granules to the cores. Preferably, the water has a temperature of between 25° C. and 75° C.; even more preferably, the water has a temperature of between 30° C. and 50° C.

According to the invention, the use of drinking water is preferred; alternatively, the use of demineralised water or softened water is possible.

As stated above, the spraying step is conducted in order to wet the outer surface of the cores. For this purpose, the quantity of water is preferably between 0.1% and 20%, more preferably between 0.5% and 10%, and even more preferably between 1.0% and 5.0% by weight of the core.

As already stated, the manufacturing process according to the invention includes a step of coating the wetted outer surface of each core with a plurality of particles of a coating substance. Said particles can be distributed on the outer surface of the cores to form one or more layers of said particles. Preferably, said coating substance consists of one or more sugars, or one or more polyols. Alternatively, said coating substance consists of a combination of one or more sugars with one or more polyols.

The particularly preferred polyols are alditols. The particularly preferred alditols are xylitol, sorbitol, maltitol, mannitol, isomalt and erythritol. The sugar or polyol crystals can also be used encapsulated or granulated, internally flavoured or coated on the surface with flavouring agents.

According to the invention, the particles of coating substance have a mean particle size greater than 50 μm, preferably between 100 μm and 700 μm, and more preferably between 200 μm and 500 p.m.

In addition to the particles of coating substance, the step of coating the wetted outer surface of the chewing gum cores may optionally include the application of powdered agents such as sweeteners, acidifiers, fruit juices, vitamins, functional ingredients and flavourings. According to the manufacturing process to which the invention relates, the water-spraying and particle-coating steps can be conducted either discontinuously or continuously.

According to the batch method, a pre-determined quantity of cores (originating from the storage station) is loaded into one or more substantially cylindrical containers (“coating pans”) which are made to rotate simultaneously with the water-spraying step. In detail, the water, of the predetermined quantity and temperature, is introduced into each container, for example by means of suitable nozzles. The process parameters, such as the rotation speed of the coating pan and the time for which the cores remain in said pan, are suitably regulated in order to achieve complete, uniform wetting of the outer surface of the cores. When the desired degree of wetting has been obtained, a suitable quantity of particles is introduced into the rotating containers. Said rotation is maintained until the particles cover the outer surface of the cores evenly and homogeneously. A surplus quantity of particles is preferably used to ensure correct coating of all the cores present in the coating pan.

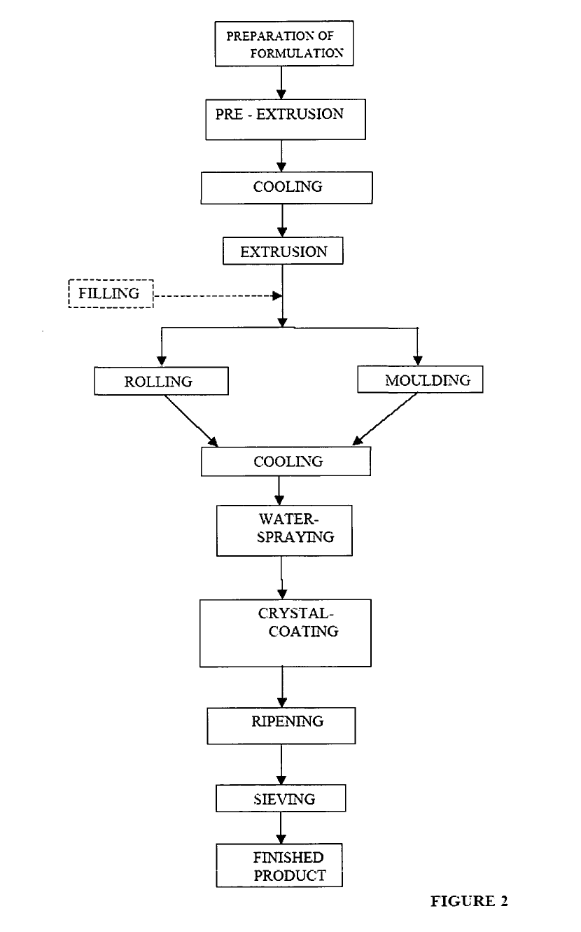

When the coating step has been completed, the cores thus treated are unloaded from the coating pan and sent to the subsequent steps of the manufacturing process, as indicated in detail below. FIG. 2 illustrates the block diagram of a second form of embodiment of the manufacturing process according to the invention.

In particular, the manufacturing process shown in FIG. 2 is a continuous process which does not include the storage step illustrated in FIGS. 1a and 1b; the cores, once obtained and cooled, are directly subjected to the water-spraying step.

With the exception of the storage step, the manufacturing process shown in FIG. 2 is therefore identical to the manufacturing process described by reference to FIGS. 1a and 1b. In particular, according to the continuous operational methodology, the cores originating from the cooling step are fed on a conveyor belt to one or more continuous coating pans rotating at a pre-determined speed. The coating pans used in continuous processes are open on two opposite sides to guarantee continuous handling of the incoming and outgoing cores. In the coating pans the cores undergo the water-spraying step according to the predetermined quantities and temperatures, in order to ensure complete, uniform wetting of their outer surface. The process parameters, such as the dimensions of the coating pans, rotation speed, transit speed and height of core bed, are suitably detected and regulated to guarantee that the water is optimally dispersed over the surface of the cores. The wet cores are unloaded from the coating pans and conveyed to a sanding station where, according to a preferred form of embodiment, the cores pass through a cascade of particles or crystals of the coating substance, which said cascade feeds a bed of particles present in one or more additional rotating coating pans. The cores are therefore dropped onto the bed of particles, whereupon said particles are deposited on the wet surface of the cores, and continue to cling to said surface. The terminal section of the sanding pans is perforated so that excess particles can fall through the holes and be recycled to said cascade.

When the spraying and coating steps (whether discontinuous or continuous) have been completed, the coated cores undergo a ripening step, which typically lasts approx. 24 hours and is conducted at a controlled temperature and humidity.

Preferably, at the end of the ripening step, the manufacturing process according to the invention also includes a step in which the coated cores thus obtained are sieved. The sieving step, preferably conducted with one or more vibrating screens, discards crystals which adhere weakly to the surface of the cores, and any non-conforming products such as agglomerates of two or more coated cores (called “doubles” in trade jargon). At the end of the sieving step the manufacturing process according to the invention is concluded, and the end product thus obtained (ie. the chewing gum constituted by said coated cores) is ready for the final packaging steps. According to the invention, the finished product (ie. the coated chewing gum) typically presents a percentage of coating substance particles amounting to over 3% of the total weight of the finished product.

Two examples of the invention, and a comparative example according to a conventional process, are set out below.

### Example 1 (Invention)

Coated chewing gum has been produced by the batch process according to the invention, as illustrated in FIGS. 1a and 1b described above. Table 1 lists the main constituents of the formulation used to make the cores.

TABLE 1
TYPE A CORE

| CONSTITUENT | % in weight |
|---|---|
| Gum base | 32.3 |
| Caramel | 0.1 |
| Hydrogenated glucose syrup | 1.5 |
| Powdered sorbitol | 45.0 |
| Xylitol | 7.5 |
| Mannitol | 7.5 |
| Aspartame | 0.5 |
| Glycerol | 3.0 |
| Natural flavourings and other additives | 2.6 |

The formulation was subjected to extrusion followed by moulding, to obtain discoid-shaped cores A. After a storage step, said cores were placed in a water bath at the temperature of 35° C. for 1 min, in a batch coating pan rotating at a speed of approx. 7 rpm. The quantity of cores A loaded into the coating pan was approx. 80 kg, and the quantity of water was approx. 1.5 kg. When the spraying step had been completed, wetted cores A underwent the step of application of the crystals of coating substance. Maltitol crystals with a mean particle size of approx. 200 μm were used. The application step was conducted in the rotating batch coating pan, into which approx. 8.0 kg of crystals was introduced. The dispersion time of the crystals on the outer surface of cores A was approx. 3 min. When the crystal application step had been completed, the coating pan was unloaded and the chewing gum thus obtained was subjected to a ripening step for 24 h, at the temperature of 23° C. and approx. 30% relative air humidity.

At the end of the ripening step, the product obtained underwent a sieving step. The finished product (ie. the coated chewing gum) presented a percentage by weight of crystals of coating substance amounting to 6% of the total weight of the product.

### Example 2 (Invention)

Coated chewing gum was produced by the continuous process according to the invention as illustrated in FIG. 2 described above. Table 2 lists the main constituents of the formulation used to make the cores.

TABLE 2
TYPE B CORE

| CONSTITUENT | % in weight |
|---|---|
| Gum base | 34.3 |
| Hydrogenated glucose syrup | 0.3 |
| Powdered sorbitol | 50.0 |
| Xylitol | 7.0 |
| Aspartame | 0.3 |
| Glycerol | 2.5 |
| Natural flavourings and other additives | 3.0 |

The formulation was subjected to extrusion followed by rolling to obtain cores B having a rectangular longitudinal cross-section with rounded corners (pillow-shaped). At the end of the cooling step, cores B were subjected to a separation step. Subsequently, using a conveyor belt, cores B were subjected to the water-spraying step at the temperature of 50° C. for a period of 30 s, in a continuous coating pan rotating at the speed of approx. 5 rpm. The flow rate of cores B introduced into the coating pan was approx. 400 kg/h, and the corresponding quantity of water sprayed was approx. 4.5 kg/h. When the spraying step had been completed, wetted cores B were conveyed to a second continuous coating pan in which they underwent the step of application of crystals of the coating substance.

Xylitol crystals with a mean particle size of approx. 500 μm were used. Approx. 100 kg of crystals was introduced into the second coating pan, rotating at a speed of approx. 10 rpm. The transit time in the crystal bed was approx. 1 min. When the step of application of the crystals had been completed, the chewing gum thus obtained was subjected to a ripening step for 24 h, under controlled temperature and humidity conditions. At the end of the ripening step, the product obtained underwent a sieving step.

### Example 3 (Comparative)

Coating chewing gum was produced by a conventional manufacturing process. In detail, cores B obtained from the constituents according to the operational methodology described in example 2 were used. At the end of the cooling and separation step, cores B were subjected to spraying with maltitol syrup and gum arabic and then to the xylitol crystal application step.

Apart from the use of the syrup instead of water at the spraying step, the continuous process described in comparative example 3 was conducted in the same plant and with the same process parameters as described above for the continuous process according to the invention described in example 2.

The process according to the invention offers a number of advantages compared with known manufacturing processes.

Primarily, other conditions being equal, the process according to the invention produces chewing gum with a larger number of particles or crystals adhering to the surface of the cores. In other words, the manufacturing process according to the invention is more effective than known manufacturing processes because the coating percentage is greater.

This aspect is clearly evident when the data contained in Tables 3 and 4 below are compared.

TABLE 3

| | Example 2 | Example 3 |
|---|---|---|
| Weight | (invention) | (comparative) |
| Weight of core B | 1.800 g/piece | 1.800 g/piece |
| Weight of core B after wetting | 1.825 g/piece | 1.825 g/piece |
| Weight of core B after application of | 1.959 g/piece | 1.920 g/piece |
| crystals | | |
| Weight of core B after sieving | 1.928 g/piece | 1.880 g/piece |
| Weight of crystals in finished product | 0.128 g/piece | 0.080 g/piece |

TABLE 4

| | Example 2 | Example 3 |
|---|---|---|
| Weight | (invention) | (comparative) |
| % weight increase of core B after wetting | 1.14% | 1.33% |
| % weight increase of core B due to | 6.95% | 5.05% |
| application of crystals alone | | |
| % weight loss of finished product after | −1.60% | −2.13% |
| sieving | | |

The values specified in Tables 3 and 4 consequently show that the manufacturing process according to the invention promotes greater adherence of the crystals to the cores, as the total weight of the crystals as a percentage of the finished product is greater in the process according to the invention than in known processes. This finding is confirmed by the fact that the product according to the invention weighs more than the product according to the prior art before the sieving step, and that the weight loss (expressed as a percentage) of the product according to the invention is lower than that of the product according to the prior art at the end of the sieving step.

Moreover, as already stated, the manufacturing process according to the invention is simple and cheap because it does not present the complexity in terms of equipment or operating conditions typical of manufacturing processes using syrups. Moreover, in at least one form of embodiment, the manufacturing process according to the invention can be conducted continuously with core manufacture, a particularly advantageous aspect in terms of reducing costs and time. Finally, as the manufacturing process according to the invention considerably reduces the production of “doubles” (two pieces of chewing gum sticking together), which inevitably represent manufacturing waste, the manufacturing process according to the invention achieves higher productivity than known processes.

1. Process for manufacturing chewing gum, said chewing gum comprising a core formed by at least one gum base and at least one sweetener, said process comprising:
a) processing a chewing gum formulation to obtain a plurality of cores, wherein said cores comprise an outer surface;
b) contacting said cores with a fluid consisting essentially of water so as to wet the outer surface of each core, and
c) coating the wet outer surface of each core with at least one coating substance in particulate form.

2. Process as claimed in claim 1, wherein the fluid is water in the liquid or steam state.

3. Process as claimed in claim 1, wherein the fluid is water at a temperature of between 20° C. and 100° C.

4. Process as claimed in claim 1, wherein said contacting in step b) is conducted by spraying, immersion or wetting.

5. Process as claimed in claim 1, wherein the water is in quantities between 0.1% and 20% by weight of the core.

6. Process as claimed in claim 1, wherein the water is drinking water, demineralised water or softened water.

7. Process as claimed in claim 1, wherein the coating substance in particulate form is selected from amorphous powder, granulates, encapsulates or crystals and combinations thereof.

8. Process as claimed in claim 1, wherein the coating substance is selected from sugars, polyols and combinations thereof.

9. Process as claimed in claim 7, wherein the coating substance is an alditol.

10. Process as claimed in claim 9, wherein the alditol is selected from xylitol, sorbitol, maltitol, mannitol, isomalt, and erythritol.

11. Process as claimed in claim 1, wherein the particles of said coating substance have a mean particle size exceeding 50 μm.

12. Process as claimed in claim 1, wherein the coating substance in particulate form is mixed with at least one powdered agent.

13. Process as claimed in claim 12, wherein said powdered agent is selected from the group consisting of sweeteners, acidifiers, fruit juices, vitamins, functional ingredients, flavouring agents and combinations thereof.

14. Process as claimed in claim 1, wherein the coating substance in particulate form is coated wholly or partly with a flavoring ingredient.

15. Process as claimed in claim 1, wherein said cores are moulded in a discoid, cylindrical, cubic or spherical shape.

16. Process as claimed in claim 1, further comprising introducing a filler into the chewing gum cores.

17. A chewing gum comprising a core formed by at least one gum base and at least one sweetener, said-chewing gum being prepared with a process comprising:
a) processing a chewing gum formulation to obtain a plurality of cores, wherein said cores comprise an outer surface;
b) contacting said cores with a fluid consisting essentially of water so as to wet the outer surface of each core, and
c) coating the wet outer surface of each core with at least one coating substance in particulate form.

18. Process as claimed in claim 3, wherein the water is at a temperature of between 15° C. and 75° C.

19. Process as claimed in claim 3, wherein the water is at a temperature of between 30° C. and 50° C.

20. Process as claimed in claim 4, wherein said contacting step b) is conducted by spraying.

21. Process as claimed in claim 5, wherein the water is present in a quantity between 0.5% and 10% by weight of the core.

22. Process as claimed in claim 5, wherein the water is present in a quantity between 1.0% and 5.0% by weight of the core.

23. Process as claimed claim 11, wherein the particles have a mean particle size between 100 μm and 700 μm.

24. Process as claimed claim 11, wherein the particles have a mean particle size between 200 μm and 500 μm.

25. Process as claimed in claim 14, wherein said flavoring ingredient is in the form of an oil.

26. Process as claimed in claim 15, wherein said cores have a longitudinal cross-section which is diamond-shaped, rectangular, or rectangular with rounded corners.
